(19) United States
(12) Patent Application Publication
(10) Pub. No.: US 2015/0170211 A1
(43) Pub. Date: Jun. 18, 2015

(54) "BREAKING NEWS" AD FORMAT AND SYSTEM

(71) Applicant: ZEDO, INC., San Francisco, CA (US)

(72) Inventors: Roy de Souza, San Francisco, CA (US); Abhijeet Kunder, San Francisco, CA (US)

(21) Appl. No.: 14/573,336

(22) Filed: Dec. 17, 2014

Related U.S. Application Data
(60) Provisional application No. 61/917,462, filed on Dec. 18, 2013.
(60) Provisional application No. 61/931,199, filed on Jan. 24, 2014.

(51) Int. Cl. G06Q 30/02; H04L 29/08

(52) U.S. Cl. CPC G06Q 30/0267; H04L 67/10; G06Q 30/0256

(57) ABSTRACT

The breaking news ad format is an innovative ad unit that helps publishers monetize their best-selling content pack in a manner never done before. In accordance with an exemplary embodiment, the ad/content format houses the following subsets of information: Breaking News Headline (Article title, optionally—a snippet and a thumbnail), Publisher Branding (Logo, additional branding message), and Auto-playing Advertiser Video (a VAST (Digital Video Ad Serving Template) compliant video ad). The ad unit can effectively be invoked using a smart trigger action engine which ensures that the user is always viewing and/or actively using the device in plain sight. The trigger action also ensures that the format is not intrusive and that it does not directly affect the usability of the device and/or intended action by the user. The context here for the publisher is that an engaging ad format can be invoked using one or more trigger points.

### PRIORITY

This application claims the benefit of and priority under 35 U.S.C. §119(e), to U.S. Patent Application No. 61/917,462 filed Dec. 18, 2013, entitled “Zedo's “Breaking News” Ad Format,” and U.S. Patent Application No. 61/931,199 filed Jan. 24, 2014, entitled “Zedo's “Breaking News” Ad Format,” both of which are incorporated herein by reference in their entirety.

### BACKGROUND

Mobile applications today offer substantial opportunity for application developers and publishers to showcase their content and product offerings to a market that is constantly evolving. Customers today are eager to consume high quality original content on multiple mediums including mobile and tablet devices. There are numerous content-rich mobile applications in the market that offer diverse forms of news, articles, publications, tabloids and other content, etc., and present their content in a wide variety of media formats. With the rapid surge in smartphone and tablet penetration, there is a growing need to bring innovation in content distribution and presentation.

### SUMMARY

For publishers, it is important that the content is delivered and offered in an engaging manner for customers to consume and interact. Publishers are also endlessly on the lookout for better ways to scale and monetize their inventory. Notably, news and publication houses are quite determined to bring their best consumable content to their readers, delivered and presented in the best possible medium. Publishers basically feel the need to bring content in their ads to make an impact. However most application developers find:

Small number of ad impressions—Many users download applications (apps) but seldom use their apps regularly so they don't have many users to show ads, and

Low CPMs—When they can show ads to users, the ads are small banner ads, not very effective and so advertisers provide only low CPMs (Cost Per Impressions)

There is a need to launch a new ad format that has high ad impressions, high CPMs and is easy for publishers to integrate, becomes imminent—the “Breaking News” Ad Format at least accomplishes these issues.

More specifically, the “Breaking News” mobile ad format is a unique approach in mobile advertising that brings substantial opportunity and revenue for publishers, content owners and distributors. The ad format presents a very novel approach for publishers to showcase one of their most successful and highly effective news content packs (viz. Breaking News) right to their readers' mobile devices. This format also allows, for example, advertisers to showcase their brand in an effective and appealing media form for consumers to engage and interact with.

The breaking news ad format is an innovative ad unit that helps publishers monetize their best-selling content pack in a manner never done before. In accordance with an exemplary embodiment, the ad/content format houses the following subsets of information (See FIG. 1):
Breaking News Headline (Article title, optionally—a snippet and a thumbnail) Publisher Branding (Logo, additional branding message)
Auto-playing Advertiser Video (a VAST (Digital Video Ad Serving Template) compliant video ad)

This ad unit will effectively be invoked using a smart trigger action engine which ensures that the user is always viewing and/or actively using the device in plain sight. The trigger action also ensures that the format is not intrusive and that it does not directly affect the usability of the device and/or intended action by the user. The context here for the publisher is that an engaging ad format can be invoked using one or more trigger points as discussed herein.

Using the Smart Trigger Action engine, the breaking news ad unit can be auto-invoked, and/or the publisher can manually choose when to display the ad unit based on an action(s) by the device owner.

The exemplary breaking news ad format attempts to address all common concerns faced by publishers, especially those in the news content & publishing houses:
1. High number of ad impressions—User will see a limited number of ads per day regardless of whether they use the app or not, and
2. High CPMs—The ad format is extremely effective and will therefore earn very high CPMs. The “smart trigger points” means that ads can be served when the user is watching the screen, which results in sustained attention span. The ads can be video ads that fill the whole screen in landscape mode, and hence are much more effective when compared with banners ads.

The exemplary breaking news ad format can also be used with mobile apps and games. For example, as the user exits an app/game, a bubble can appear. Tapping the bubble leads to a story and the video, and the ad can remains as the user scrolls down. Research has shown that this yields an average CTR of 3%. Some of the exemplary benefits associated with this format are:

Latest News Story—Users who tap the bubble can see a breaking news story or latest alert, with a video ad on top.

Polite & Premium—Shown when the user is not busy with the smartphone, and accompanied by time and frequency capping.

Non-Intrusive—Polite bubble gently reminds the user of new stories and users can choose to opt out.

Easy to Implement—Simple SDK Integration into an app with no additional work.

The Breaking News ad format can be compliant with all known advertising standards. This format adds a new dimension to high impact advertising formats thus empowering publishers to increase their revenue and helps augment advertisers with high-impact engaging video advertising.

In addition to the above on-the-ground features, the exemplary ad unit can comply with standard ad serving and targeting rules and can also house one or more of the following exemplary features:

Allow Publisher's Video content to be played after the ad (i.e., ad is pre-roll)

Allow category wise targeting (via data providers)

Prominent Close button

Allow users to opt-out

Allow ads to be downloaded on Wi-Fi only (can be explicitly set by publisher)

Ability to snooze (by hour, day)

Ability to introduce an overlay that shows on the video after the video is complete

Allow user to mute/unmute video ad

Allows Publisher to set audio off on ad launch

VAST 3.0 with all tracking (impression, click, quartiles, events, wrapper ads etc.)

Client side default capping (publisher defined)

Campaign wise capping

Enable click-throughs by default (with ability to disable clicks altogether)

Additional aspects are directed toward:

A communications device comprising:

a smart trigger action engine,

a processor, and

a memory, the smart trigger action engine adapted to detect a time when a user is receptive to receiving one or more of an ad and content; and

an ad presentation module adapted to present the one or more of the ad and the content at the time.

Even further aspects are directed toward:

A communications method comprising:

detecting, by a smart trigger action engine, when a user is receptive to receiving one or more of an ad and content; and

presenting the one or more of the ad and the content at the time.

Still further aspects are directed toward:

A communications system comprising:

means for detecting, by a smart trigger action engine, when a user is receptive to receiving one or more of an ad and content; and

means for presenting the one or more of the ad and the content at the time.

Yet even further aspects are directed toward:

A non-transitory computer-readable information storage media having stored thereon instructions, that when executed by one or more processors, cause to be performed a method comprising:

detecting, by a smart trigger action engine, when a user is receptive to receiving one or more of an ad and content; and

presenting the one or more of the ad and the content at the time.

The present disclosure can provide a number of advantages depending on the particular aspect, embodiment, and/or configuration.

These and other advantages will be apparent from the disclosure and discussion herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE FIGURES

FIG. 1 illustrates an exemplary content providing environment;

FIG. 2 illustrates an exemplary operation of the content providing system;

FIG. 3 illustrates a flowchart of an exemplary method of operation of the content providing system;

FIG. 4 illustrates a flowchart of another exemplary method of operation of the content providing system;

FIG. 5 illustrates exemplary flow control of the content providing environment; and

FIG. 6 illustrates another exemplary operation of the content providing system.

In the appended figures, similar components and/or features may have the same reference label. Furthermore, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

For purposes of explanation, numerous details are set forth in order to provide a thorough understanding of the embodiments of the present invention. It should be appreciated however that the present invention and disclosed embodiments may be practiced in a variety of ways beyond the specific details set forth herein. Furthermore, while the exemplary embodiments illustrated herein show some of the various components of the system collocated, it is to be appreciated that the various components of the system can be located at distant portions of a distributed network, such as a communications network, node, and/or the Internet, or within a dedicated secured, unsecured, and/or encrypted system and/or within a cloud computing environment.

Thus, it should be appreciated that the components of the system can be combined into one or more devices, or split between devices, such as a computer, a computing device, a server, or the like. As will be appreciated from the following description, and for reasons of computational efficiency, the components of the system can be arranged at any location within a distributed network without affecting the operation thereof. Similarly, one or more of the functional portions of the system could be distributed between one or more computing devices.

Furthermore, it should be appreciated that the various links connecting the elements, including any communications channel(s) connecting the elements, can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol.

In greater detail, one exemplary embodiment is directed toward providing content, such as audio, video, multimedia and/or text content, on a mobile device—such as a smartphone. In general however the techniques disclosed herein can be implemented and extended to any computing or communications and/or gaming device and can include any type of content including, for example, ads, videos, pictures, audio/visual information, multimedia, text information, other information, or the like.

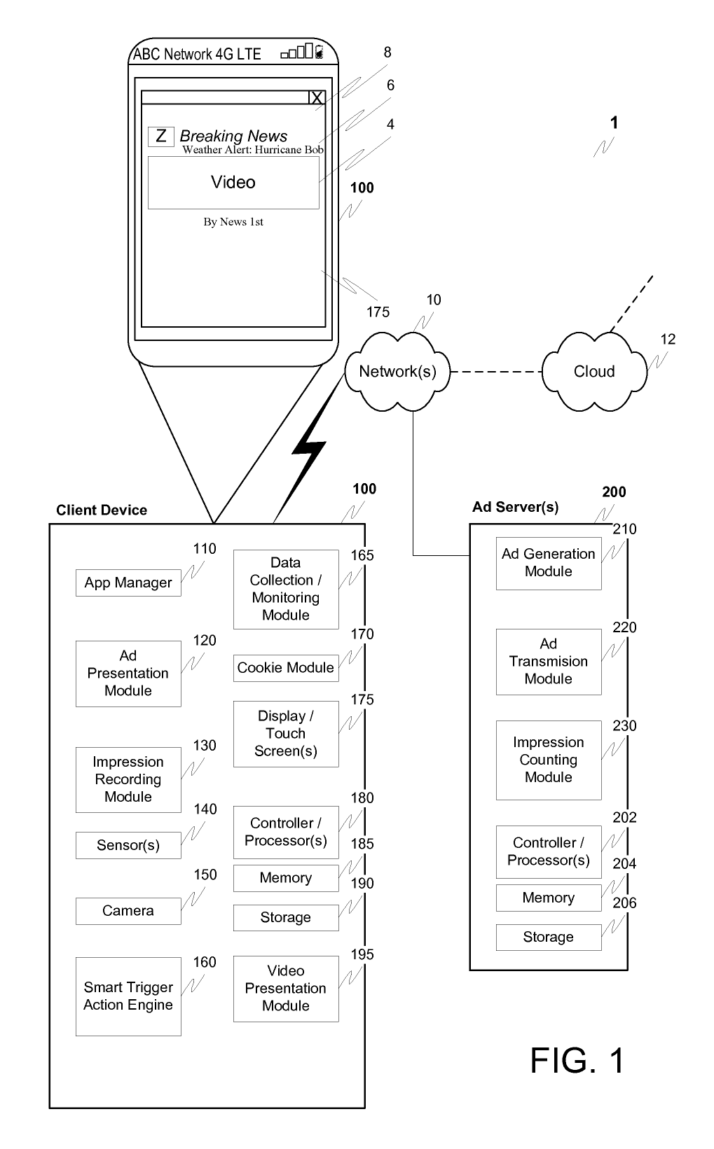

FIG. 1 illustrates an exemplary content providing environment 1. The content providing environment 1 includes a client device 100, and ad server 200, one or more networks 10 and one or more clouds 12. An exemplary embodiment of the ad server 200 compromises an ad generation module 210, an ad transmission module 220, an impression counting module 230, controller/processor 202, memory 204, storage 206, as well as conventional and well known componentry. While the following description will be discussed in relation to ads, it is to be appreciated as discussed above that the ad server 200 can provide any type(s) of content.

An exemplary embodiment of the client device 100 includes an app (application) manager 110, an ad presentation module 120, an impression recording module 130, one or more sensors 140, a camera 150, a smart trigger action engine 160, a data collection/monitoring module 165, a cookie module 170, one or more displays/touch screens 175, controller/processor 180, memory 185, storage 190 and a video presentation module 195. As discussed an exemplary embodiment will be discussed in relation to an embodiment where the client device 100 is a smartphone, however, the client device can in general be any device capable of displaying content in the manner described herein.

To begin, and in accordance with an exemplary operational embodiment, a user downloads an application from, for example, an app developer and/or an ad server in cooperation with the app manager 110. Typically there are two options for downloading of an application: 1) download for free—with the understanding that the user may receive advertisements form, for example, one or more sponsors, or 2) pay a fee, such as a one-time or recurring fee for the use of the application. Generally, but not always, the payment of the fee reduces or eliminates the advertisements the application downloader will receive.

Generally, if the application is downloaded or provided for free, the user, i.e., the application downloader, will need to opt in to confirm that it is acceptable for the user to receive ads as a condition to being provided the application for free. In accordance with one exemplary embodiment, a second or double opt-in process is provided to confirm the opt-in, such as through an email confirmation message.

Upon opting in, the smart trigger action engine 160 monitors for one or more conditions and/or sensor(s) 140 thresholds. These conditions can be associated with a time when the user may be most receptive to receiving an ad from the ad presentation module 120 and from the ad transmission module 220.

For example, and in accordance with one exemplary embodiment, the smart trigger action engine 160 detects the completion of an event, such as hanging up the phone or by completing some other task on the device 100. This completing of an event has been determined to be one example of a time when a user is more receptive to receipt of an ad from the ad presentation module 120.

The smart trigger action engine 160 can also consider other factors such as, time of day, one or more thresholds, e.g., was the call longer than 60 seconds, and in general can consider any other available factor in determining whether a triggering condition(s) has been satisfied. Other factors include whether the user is currently engaging the device, such as a smartphone, and what is the likelihood that the user will hear/see the ad. Other factors include whether the user is looking at the device 100 (as detected by camera 150), whether the user is holding the device as detected by one or more sensors 140 (such as an inductive/capacitive sensor and/or motion detector), whether the user is engaged in some other activity on the device (as detected by the processor 180/memory 185), whether the user is using an app (as detected by the app manager 110), the changing of wallpaper, or the like. In accordance with another exemplary embodiment, the data collection/monitoring module 165 tracks one or more of data usage and data type, and monitors data on the device 100 which can be used as a trigger for the smart trigger action engine 160. In general, any activity and/or sensed condition can be used by the smart trigger action engine 160 to initiate an ad presented by the ad presentation module 120. Even further factors/conditions include one or more of: widget action on a home-screen, a change in Bluetooth® state, a change in wireless mode, a sending or receipt of a text message, a change of radio state (Airplane Mode), a change of volume or ringer state, an insertion or removal of a headset into the headphone jack, a docking or undocking of the device via USB or WiFi, a search activity initiated on the device, a locking or unlocking of the device, a screen on or screen off state change, a change in alarm state or value, a change in battery state or value, or the like.

Once a triggering event has been detected by the smart trigger action engine 160, in accordance with one exemplary embodiment, a pre-cached advertisement is downloaded from one or more of the cloud 12 and ad server(s) 200 and stored in storage 190 and/or memory 185, and is presented in cooperation with the video presentation module 195 as shown on the device 100 in FIG. 1. Here, in this exemplary embodiment, a video 4, such as an ad, is shown with associated content 6 in application window 8 on the device screen 175. While not required, one exemplary advantage to having a pre-cached ad is that the user experience can be improved in that the ad, especially if it is video, is smooth and seamless. This pre-caching can commence any time after the application is installed, and is not limited to video, but in general any content that will be presented to a user in cooperation with the ad presentation module 120. Additionally or alternatively, and in conjunction with the presentation of an ad by the ad presentation module 102, one or more of the impression recording module 130 and impression counting module 230 can track the number of times the ad/content has been presented. Additionally or alternatively, one or more of the impression recording module 130 and impression counting module 230 can track the activity that triggered the smart trigger action engine 160 to present the ad/content.

Upon presentation of the advertisement, additional actions can also occur such as turning on the sound to a pre-defined level, determining whether the device is in a portrait or landscape orientation and adjusting the advertisement accordingly, optionally making the advertisement full screen, and the like. These preferences can be governed by the controller 180 in cooperation with, for example, one or more user preferences stored in storage 190 and/or one or more preferences associated with an app that was downloaded. For example, the app may recommend setting a volume level at 50% based on information from one or more sensors 140.

Moreover, the number of ads can be tracked/counted as discussed in accordance with one or more of the impression recording module 130 and impression counting module 230 such that the user is only presented with a certain number of ads in a given time frame. In the event the threshold number of ads has been reached for a given timeframe, even though a triggering event has been detected an ad may not presented until the counter is reset and/or the smart trigger action engine 160 determines another ad should be presented.

In addition to one exemplary embodiment where video content is generated by the ad generation module 210 and displayed on the device 100, additional information can also be presented as illustrated above. This additional content can include one or more of a headline, an article title, a snippet, a thumbnail, publisher branding (e.g., a logo, an additional branding message, etc.), link(s), and the like.

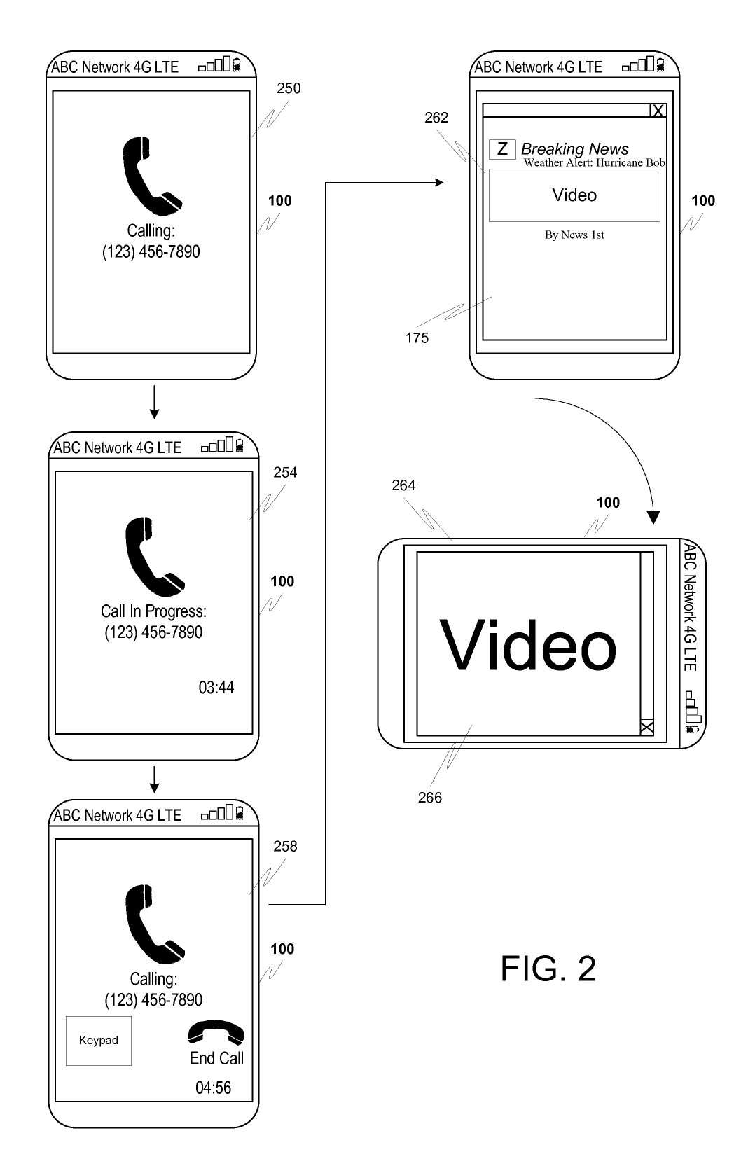

FIG. 2 shows exemplary screen captures which illustrate exemplary steps a user takes to experience an exemplary embodiment of the advertising techniques disclosed herein (here the user has already download an app, and opted in for the advertising, e.g., Breaking News Ad format):

1) A user dials a number on device 100 as shown in 250,

2) The user has a conversation that exceeds the threshold. Here in step 254, the call has been in progress for 03:44, and the exemplary threshold was set at 03:00, at which point it was determined by the smart trigger action engine 160 that an ad/content should be presented.

3) The user ends call in step 258. The call ended at 04:56.

4) The smart trigger action engine 160 initiates auto-play of the ad in step 262 and serves the ad on display 175 (optionally with the sound on the device turned on/off/at a specified volume level).

5) In step 264, and if the user rotates the device 100, the Breaking News Ad format can optionally rotate the ad, to enable full screen video 266.

Some of the exemplary advantages associated with the techniques described herein are as follows:

The technology can provide, for example, a “News Page” with an ad on it—Most providers only showcase ads. The techniques discussed herein can create a new inventory and ad space.

The exemplary ad can be served automatically with the cooperation of the smart trigger action engine 160 even though the app isn't open.

In accordance with one exemplary embodiment, a publisher may not decide when to show the ad. With the smart trigger action engine 160, the described technology can determine if/when to show the ad(s)/content.

Another exemplary advantage of the techniques discussed herein is that the system controls when to show the ad (e.g., afternoon). This control can be associated with the smart trigger action engine 160 functionality.

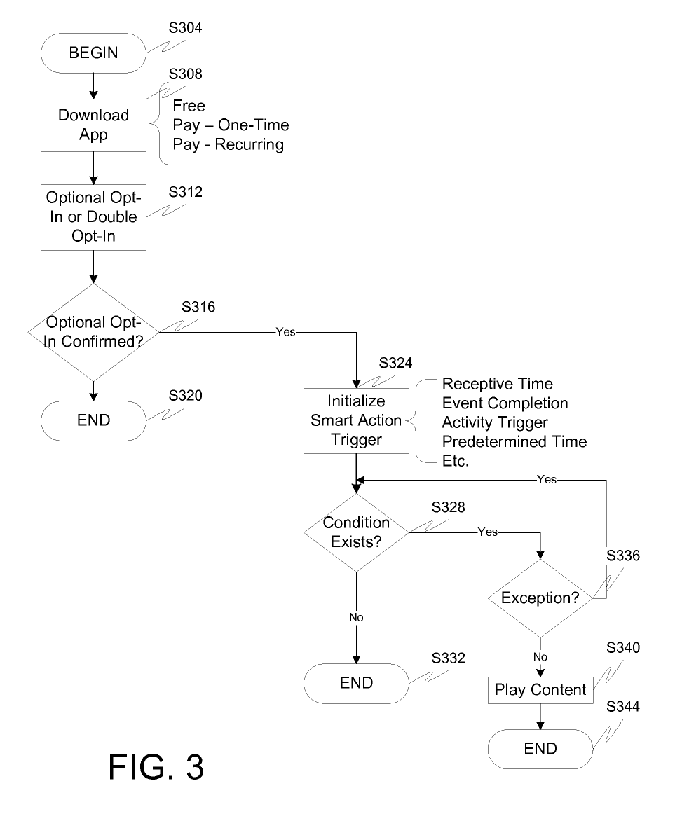

FIG. 3 outlines an exemplary method of operation of the systems described herein. Control begins in step S304 and continues to step S308. In step S308, an app(s) is downloaded. As discussed, the app can be free, or paid for such as one time or recurring. Next, in step S312, an opt-in or double opt-in is optionally performed. Then, in step S316, it is determined whether the opt-in or double opt-in was confirmed. If confirmed, control continues to step S324, with control otherwise continuing to step S320 where the control sequence ends.

In step S324, the smart trigger action engine is initialized to determine when to present content/video to the user on device 100. As discussed, the smart trigger action engine determines when is a prime receptive time for the user using device 100 to see the content/video. As further discussed, the smart trigger action engine can also invoke delivery of the ad/content based on even completion, an activity trigger, one or more timers, at a predetermined time(s), or the like.

Next, in step S238, a determination is made whether a condition exists to cause display of the content/video. If a condition does exist, control continues to step S336, with control otherwise continuing to step S332 when the control sequence ends.

In step S336, a determination is made as to whether an exception exists where the content/video should not be presented. For example, if it is determined that a user is driving based, for example, on GPS information, this may be characterized as an exception condition where control continues back to step S320 and the content/video not played. Other exceptions may exist as well such as user preferences, publisher preferences, the ad/content has already been shown a predetermined number of times, the user is not holding or looking at the device 100, etc.

If an exception does not exist, control continues to step S340 where the content/video is presented with control continuing to step S344 where the control sequence ends.

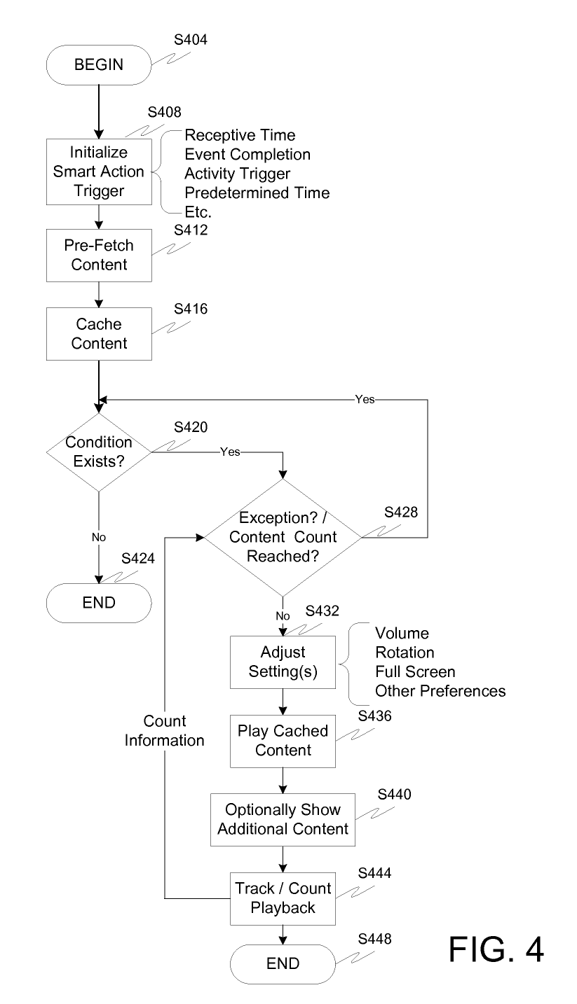

FIG. 4 outlines an exemplary method of presenting an ad/content on the device 100. In particular, control begins in step S404 and continues to step S408. In step S408, the smart trigger action engine is initialized. Next, in step S412, ad/content is pre-fetched from one or more of an ad server and the cloud. Next, in step S416, the ad/content is cached and stored in memory. Control then continues to step S420.

In step S420, a determination as to whether a condition exists that acts as a trigger for the smart trigger action engine to present the ad/content. If a condition does exist, control continues to step S428 with control otherwise continuing to step S424 where the control sequence ends.

In step S428, a determination is made as to whether an exception exists where the content/video should not be presented. For example, if it is determined that a user is driving based, for example, on GPS information, this may be characterized as an exception condition where control continues back to step S320 and the content/video not played. Other exceptions may exist as well such as user preferences, publisher preferences, the ad/content has already been shown a predetermined number of times, the user is not holding or looking at the device 100, etc. If an exception exists, control jumps back to step S420 with control otherwise continuing to step S432.

In step S432, one or more settings can be automatically or semi-automatically adjusted. For example, based on one or more user preferences, device settings and/or published preferences, one or more of volume, orientation, whether to display in full screen, or the like, can be adjusted. Next, in step S436, the cached content is displayed. Optionally, in step S440, additional content can be shown separately or in conjunction with the ad/content that was displayed. (See for example FIG. 1) Then, in step S444, an ad/content impression count is counted with control continuing to step S448 where the control sequence ends.

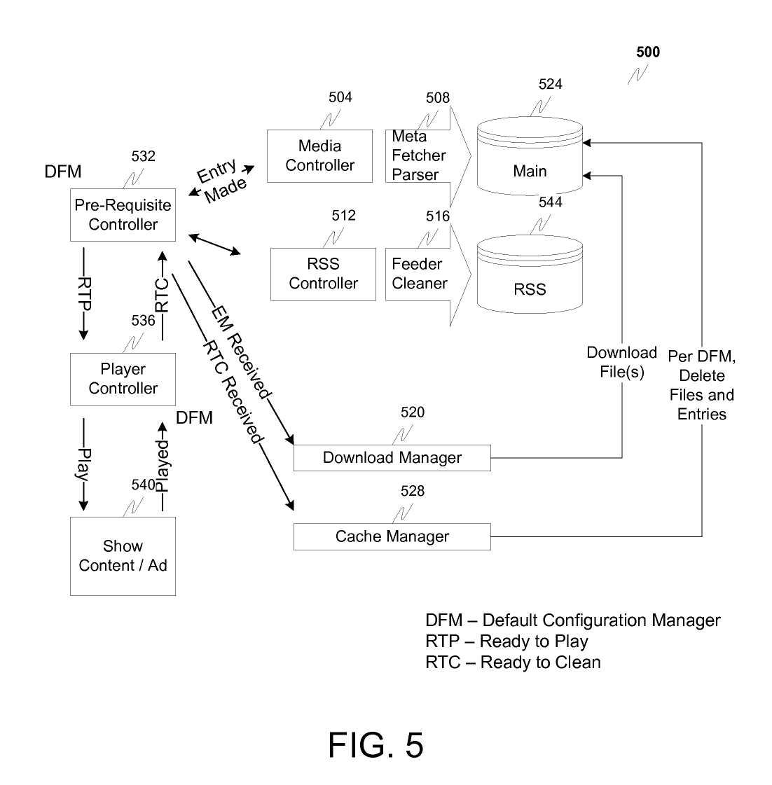

FIG. 5 illustrates and exemplary operational diagram for pre-caching media, with RSS (Really Simple Syndication) and cloud-sync for settings management.

In accordance with one exemplary embodiment, the breaking news SDK (Software Development Kit) employs a clever pre-fetching and caching module that brings seamless media ad serving to its high impact ad unit. At the core lies a caching engine that commands multiple lightweight background services together ensuring comprehensive fill rates at all times. The caching engine is supplemented with a cloud based configuration manager which administers optimal settings at all times. This cloud based update manager allows default settings to be stored in the cloud while allowing frequent updates to be monitored and applied efficiently across devices that house the SDK implemented mobile application.

Pre-Caching Media Files & RSS Feeds

FIG. 5 shows exemplary components housed inside the caching engine 500 and a device and the flow of data across its services. The caching engine 500 comprises multiple components: a media controller 504 which houses a meta fetcher as well as the parser service 508. An RSS controller 512 controls a feeder and clean-up service 516. A download manager 520 downloads media files from a database 524. A cache manager 528 unifies the components and communicates with the main data store in database 524.

In operation, an entry is made (EM) with the media controller 504 to fetch/parse content from the data store 524. In conjunction with this operation, the RSS controller 512, in cooperation with the feeder/cleaner 516 retrieves information from the RSS database 544. The pre-requisite controller 532, communicates to the download manager 520 that an EM has been received to present an ad/content, and the ad/content retrieved from the data store 524. Once downloaded, the pre-requisite controller 532 issues a ready to play instruction to the player controller 536 which in turn causes the presentation of the ad/content on player 540. Once played, the player controller 536 issues a ready to clean instruction to the pre-requisite controller 532 which in turn issues a ready to clean instruction to the cache manager 528 that, in accordance with a default configuration manager, optionally deletes one or more files and entries from the data store 524.

These components, its services and their subsidiary modules can work in tandem and warrant an efficient service oriented architecture that is designed for speed even on lower specification devices and ensures that it has an extremely light imprint on the device's memory and CPU.

Cloud-sync for Settings/Configuration

The exemplary Breaking News SDK also houses a cloud-based synchronization and update tool for common settings and configurations. This includes default parameters and their values, user settings, core system configurations and many more key value pairs. One exemplary purpose of this cloud-based update apparatus is to ensure that trivial value based changes to configurations do not require a new SDK to be implemented on the client's mobile application. This system efficiently ensures that all users with the SDK integrated within the mobile applications are periodically and systematically updated with the most recent and optimal settings.

For purposes of explanation, numerous details are set forth in order to provide a thorough understanding of the embodiments of the present invention. It should be appreciated however that the present invention and disclosed embodiments may be practiced in a variety of ways beyond the specific details set forth herein. Furthermore, while the exemplary embodiments illustrated herein discuss some of the various components of the system collocated, it is to be appreciated that the various components of the system can be located at distant portions of a distributed network, such as a communications network, node, and/or the Internet, or within a dedicated secured, unsecured, and/or encrypted system and/or within a cloud computing environment.

Thus, it should be appreciated that the components of the system can be combined into one or more devices, or split between devices, such as a computer, a computing device, communications device, smartphone, a server(s), server farm, or the like. As will be appreciated from the following description, and for reasons of computational efficiency, the components of the system can be arranged at any location within a distributed network without affecting the operation thereof. Similarly, one or more of the functional portions of the system could be distributed between one or more computing devices.

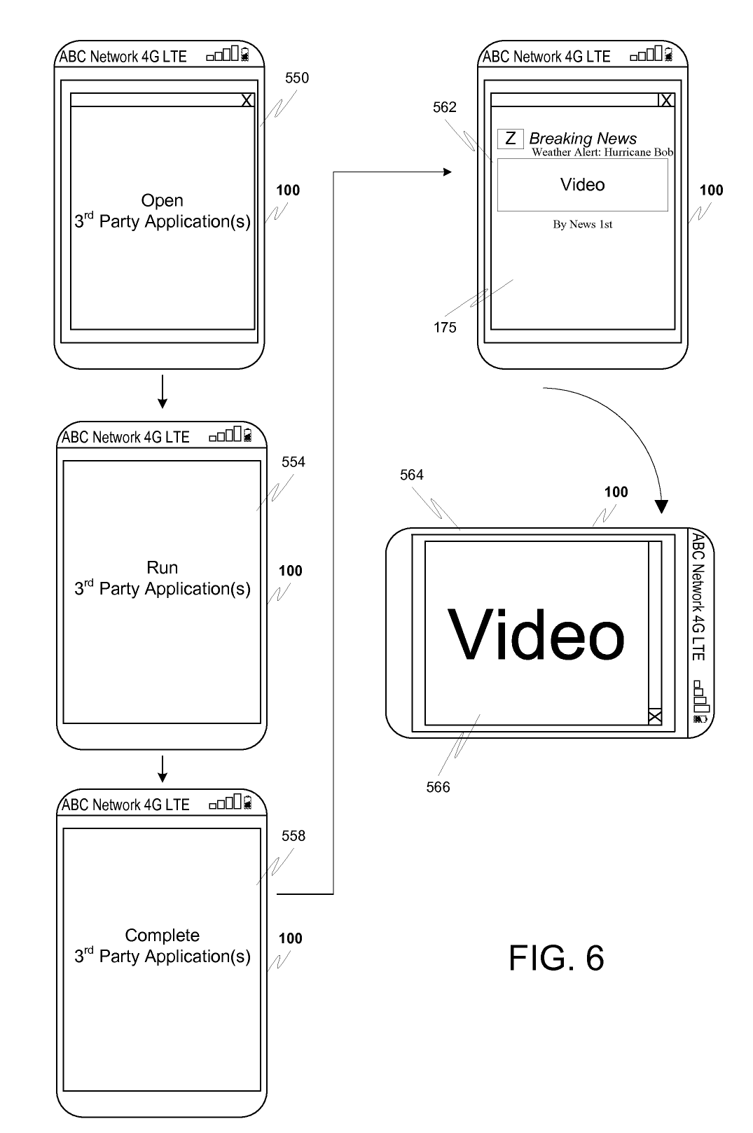

FIG. 6 shows another set of exemplary screen captures which illustrate exemplary steps a user takes to experience another embodiment of the advertising techniques disclosed herein (here the user has already download an app, and opted in for the advertising, e.g., Breaking News Ad format). In this embodiment, the displaying of the content/ad is based on the user using one or more apps, the assumption being that if the user is interacting with their device, they are more likely to being receptive to receipt of content. Here, the smart trigger works in a similar manner to the embodiment described above, one difference being in accordance with this embodiment, the triggering event is the closing or minimizing of an application. (Other triggering events are also possible such as usage of an app for a certain period, user engagement with the app such as through device inputs, accelerometer or other sensor inputs, or the like) More specifically the steps are:

1) A user open one or more apps on device 100 as shown in 550,

2) The user runs the app. Here in step 554, the user is interfacing with the application on device 100. Based on the running of the app, and/or with reference to a threshold, the smart trigger action engine determines that an ad/content should be presented to the user.

3) The user closes or minimizes the app in step 558.

4) The smart trigger action engine 160 initiates auto-play of the ad/content in step 562 and serves the ad/content on display 175 (optionally with the sound on the device turned on/off/at a specified volume level).

5) In step 564, and if the user rotates the device 100, the Breaking News Ad format can optionally rotate the ad, and/or enable full screen video 566.

Some of the exemplary advantages associated with the techniques described herein are as follows:

The technology can provide, for example, a “News Page” with an ad on it—Most providers only showcase ads. The techniques discussed herein can create a new inventory and ad space.

The exemplary ad can be served automatically with the cooperation of the smart trigger action engine 160 even though the app isn't open.

In accordance with one exemplary embodiment, a publisher may not decide when to show the ad. With the smart trigger action engine 160, the described technology can determine if/when to show the ad(s)/content.

Another exemplary advantage of the techniques discussed herein is that the system controls when to show the ad (e.g., afternoon). This control can be associated with the smart trigger action engine 160 functionality.

Furthermore, it should be appreciated that the various components can be connected via one or more links, and any communications channel(s) connecting the elements can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol.

An exemplary operational environment, in which the techniques disclosed herein may operate, includes one or more client computers or communications devices such as smartphones, one or more web servers, and one or more ad servers, interconnected via one or more networks and links. While an exemplary embodiment will be discussed where the web servers and ad servers are illustrated as separate components, it should be appreciated that these elements could be combined and hosted from the same server.

An exemplary embodiment of the client computer/communications device compromises: a smart trigger monitoring module, an ad presentation module, an impression recording module, a process and function recording module, a data collection/monitoring module, a cookie module, controller/processor, memory and storage, as well as conventional and well known componentry.

An exemplary embodiment of the ad server compromises an ad generation module, an ad transmission module, an impression counting module, controller/processor, memory, storage, as well as conventional and well known componentry that have been omitted for clarity.

The exemplary systems and methods of this disclosure have been described in relation to an advertising system and techniques as well as triggering event(s). However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein discuss the various components of the system collocated, certain components of the system can be located remotely, at distant portions of a distributed network, such as a LAN and/or the Internet, or within a dedicated system and/or within a cloud computing environment. Thus, it should be appreciated, that the components of the system can be combined in to one or more devices, such as a computer, computing device and/or server(s), or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flow of steps have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A communications device comprising:
a smart trigger action engine,
a processor, and
a memory, the smart trigger action engine adapted to detect a time when a user is receptive to receiving one or more of an ad and content; and
an ad presentation module adapted to present the one or more of the ad and the content at the time.

2. The device of claim 1, wherein the time is at the completion of an event or a condition on the device.

3. The device of claim 1, wherein the time is at the completion of an event that exceeds a predetermined duration.

4. The device of claim 3, wherein the event is a phone call.

5. The device of claim 1, further comprising storage configured to pre-cache one or more media files.

6. The device of claim 1, further comprising storage configured to pre-cache one or more RSS (Really Simple Syndication) feeds.

7. The device of claim 3, wherein the event is the launch or exit of an application.

8. The device of claim 3, wherein the event is a wallpaper change on the device.

9. The device of claim 3, wherein the event is a widget action on the home-screen.

10. The device of claim 3, wherein the event is a change in Bluetooth state.

11. The device of claim 3, wherein the event is a change in Wireless mode.

12. The device of claim 3, wherein the event is the action of sending or receipt of a text message.

13. The device of claim 3, wherein the event is the change of radio state (Aerpolane Mode).

14. The device of claim 3, wherein the event is the change of volume or ringer state.

15. The device of claim 3, wherein the event is the insertion or removal of a headset into the headphone jack.

16. The device of claim 3, wherein the event is the docking or undocking of the aforementioned device via USB or WiFi.

17. The device of claim 3, wherein the event is a search activity initiated on the aforementioned device.

18. The device of claim 3, wherein the event is the locking or unlocking of the aforementioned device.

19. The device of claim 3, wherein the event is the screen on or screen off state.

20. The device of claim 3, wherein the event is a change in alarm state or value.

21. The device of claim 3, wherein the event is a change in battery state or value.

22. A system comprising:
an electronic device including a processor, display, memory and storage; and
a smart trigger action engine, the smart trigger action engine adapted to detect one or more triggering events correlated to when a user is receptive to receiving one or more of an ad and content; and
an presentation module adapted to present the one or more of the ad and the content as a result of the detection, wherein the one or more of the ad and the content is pre-cached in the storage.
